(19) United States
(12) Patent Application Publication
(10) Pub. No.: US 2015/0366011 A1
(43) Pub. Date: Dec. 17, 2015

(54) LIGHT SOURCE CONTROLLERS

(71) Applicant: O2MICRO, INC., SANTA CLARA, CA (US)

(72) Inventors: Da LIU, Milpitas, CA (US); Horia UDREA-SPENEA, Sunnyvale, CA (US)

(21) Appl. No.: 14/304,538

(22) Filed: Jun. 13, 2014

(51) Int. Cl. H05B 33/08; H05B 37/02

(52) U.S. Cl. CPC H05B 33/0815; H05B 37/02

(57) ABSTRACT

A controller includes current setting circuitry and voltage regulation circuitry. The current setting circuitry can selectively operate in different states that include a strobe state and an idle state. The current setting circuitry sets a current of a light source to a first current level in the strobe state such that the light source emits light, and sets the current to a second current level that is less than the first current level in the idle state such that the light source disables emission of light. The voltage regulation circuitry regulates an output voltage that powers the light source to be in a voltage range with the current at the first current level in the strobe state such that the light source emits light, and maintains the output voltage at a voltage level in the voltage range in the idle state.

### BACKGROUND

Light sources, e.g., LEDs (light emitting diode), can be used in many applications such as mobile phones, tablet computers, cameras, and portable chargers. In some of these applications, a light source is used as a strobe light that continuously strobes. For example, a camera usually has a strobe light installed thereon. If a user uses the camera to shoot continuous photos in a dark place, the strobe light may need to strobe continuously. Similarly, a mobile device such as a mobile phone or a tablet computer may have a camera module and a light source installed thereon. The light source may need to strobe continuously if a user uses the mobile device to shoot continuous photos. In these applications, the light source is controlled by a light source controller.

FIG. 1 illustrates a block diagram of a conventional light source controller 150. The controller 150 receives input power via a power input terminal 154 and controls a power path 156 to regulate an output voltage V_{OUT} that powers a light source 104. The power path 156 may include circuitry that converts the input power to the output voltage V_{OUT}, and a switch circuit 152 that selectively enables or disables the generating of the output voltage V_{OUT}. By alternately turning on and off the switch circuit 152, the controller 150 controls the light source 104 to strobe continuously. However, due to some energy storage circuits, e.g., the output capacitor C_{OUT} coupled to the light source 104 and/or energy storage components inside the controller 150, whenever the generating of the output voltage V_{OUT} is enabled to power the light source 104, it may take a relatively long time for the output voltage V_{OUT} to increase from a low voltage level, e.g., zero volts, to a sufficiently high voltage level that enables the light source 104 to emit light. In other words, the light source 104 may not be able to strobe at a relatively high frequency. A camera or a mobile device with a camera module may not be able to shoot continuous photos with strobe light relatively fast when using the controller 150. Thus, a light source controller with ability to enable a light source to emit light within a relatively short time would be beneficial.

### SUMMARY

In one embodiment, a controller includes current setting circuitry and voltage regulation circuitry. The current setting circuitry selectively operates in different states that include a strobe state and an idle state. The current setting circuitry sets a current of a light source to a first current level in the strobe state such that the light source emits light, and sets the current to a second current level that is less than the first current level in the idle state such that the light source disables emission of light. The voltage regulation circuitry regulates an output voltage that powers the light source to be in a voltage range with the current at the first current level, in the strobe state, such that the light source emits light, and maintains the output voltage at a voltage level in the voltage range in the idle state.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates a block diagram of a conventional light source controller.

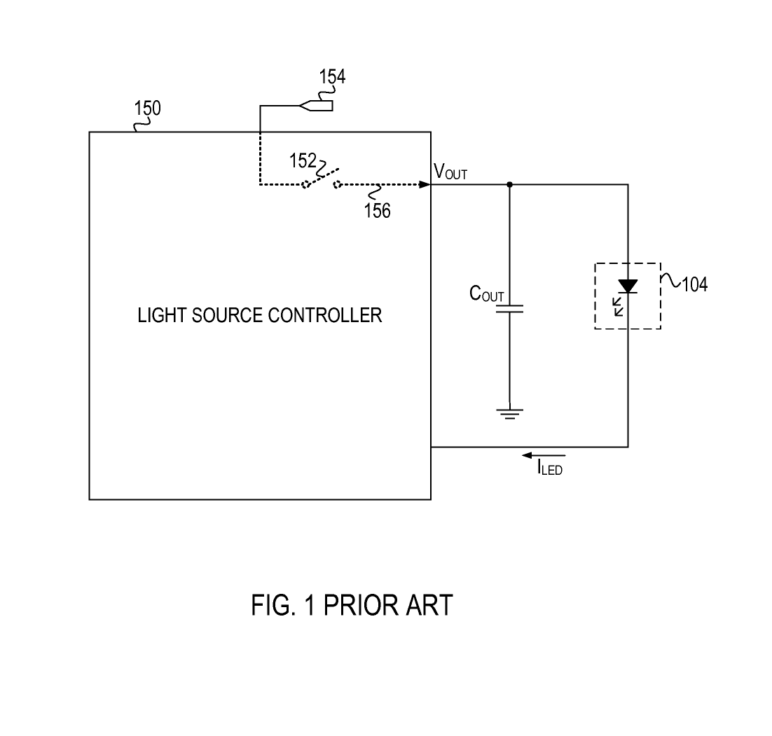

FIG. 2A illustrates a block diagram of an example of a light source controller, in an embodiment according to the present invention.

FIG. 2B illustrates a circuit diagram of an example of a light source controller, in an embodiment according to the present invention.

FIG. 3 illustrates a block diagram of an example of a light source controller, in an embodiment according to the present invention.

FIG. 4 illustrates a block diagram of an example of a light source controller, in an embodiment according to the present invention.

FIG. 5 illustrates a flowchart of an example of a method for controlling a light source, in an embodiment according to the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

In one embodiment according to the present invention, a light source controller is provided to control a light source to illuminate, strobe for one time, or strobe continuously. The controller can control the light source to emit light within a relatively short time. Thus, when the light source is used to strobe continuously, the light source can strobe at a relatively high frequency.

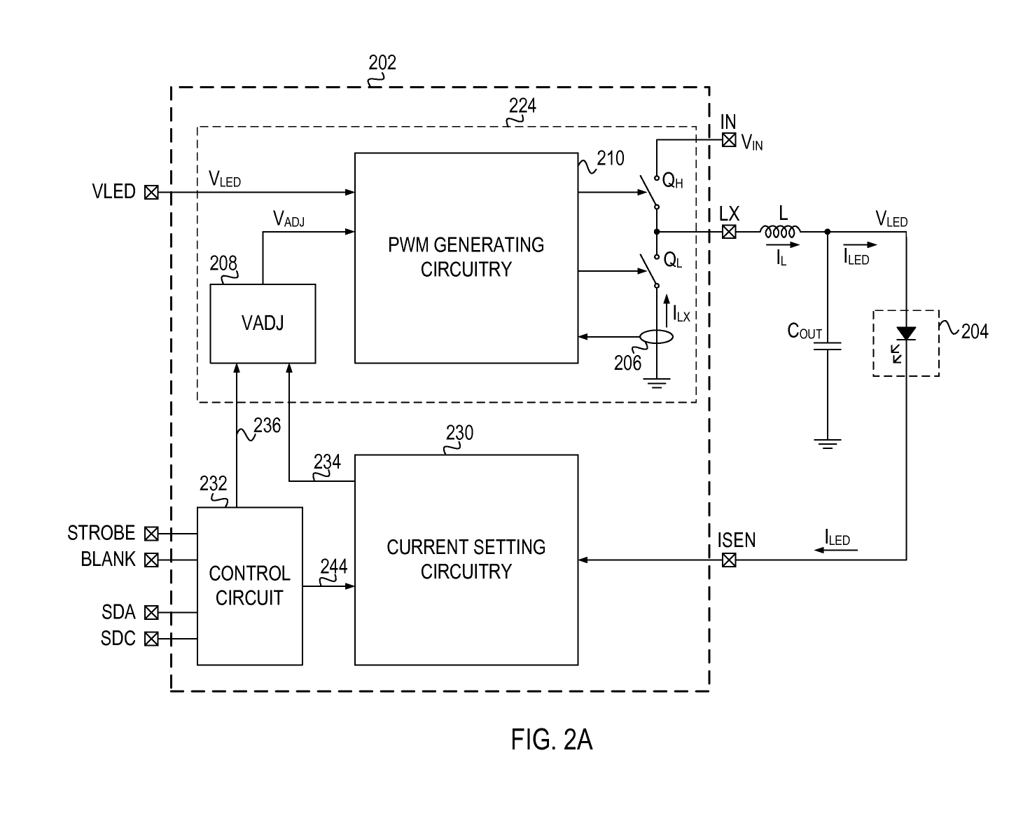

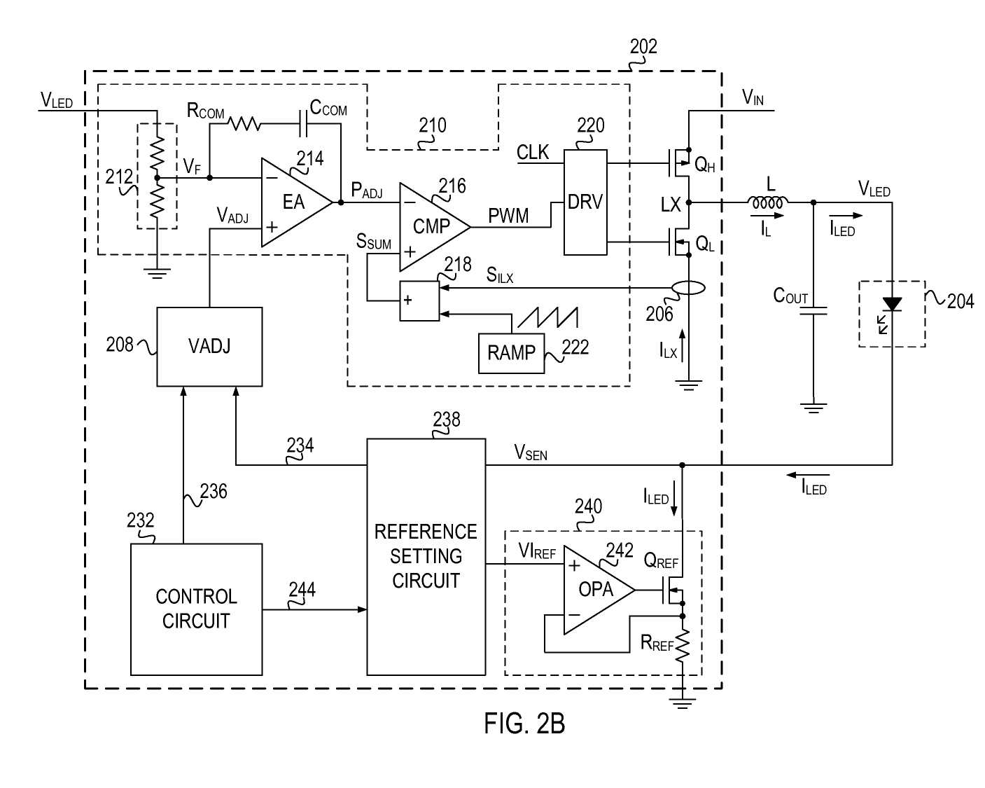

FIG. 2A illustrates a block diagram of an example of a light source controller 202, in an embodiment according to the present invention. The controller 202 can control a light source 204 through an inductor L and a filter component C_{OUT}. Although FIG. 2A discloses only one light emitting diode (LED) in the light source 204, the invention is not so limited. In another embodiment, the light source 204 includes multiple LEDs coupled in series or parallel. In yet another embodiment, the light source 204 includes another kind of light emitting component or components. For example, the light source 204 may include one or more light emitting components that emit invisible light such as infrared light, ultraviolet light, etc.

As shown in FIG. 2A, the controller 202 includes voltage regulation circuitry 224, current setting circuitry 230, and control circuit 232. The voltage regulation circuitry 224 can receive an input voltage V_{IN} and cooperate with the inductor L and the filter component C_{OUT} to regulate an output voltage V_{LED} that powers the light source 204 to a target voltage V_{TARGET}. The current setting circuitry 230 can sense a current I_{LED} flowing through the light source 204, and generate a control signal 234 indicative of the current I_{LED} to adjust the target voltage V_{TARGET} so as to maintain the current I_{LED} at a preset current level I_{PRE}. When the current I_{LED} is at the current level I_{PRE}, the light source 204 emits light at a predetermined brightness level. The current setting circuitry 230 can also set the current I_{LED} to another preset current level I_{RL} that is less than the current level I_{PRE} such that the light emitted from the light source 204 is extinguished. The control circuit 232 can generate control signals 236 and 244 to control the voltage regulation circuitry 224 and the current setting circuitry 230.

More specifically, in the example of FIG. 2A, the voltage regulation circuitry 224 includes PWM (pulse width modulation signal) generating circuitry 210 that controls an inductor current I_{L} of the inductor L by alternately turning on a high-side switch Q_{H} and a low-side switch Q_{L}, so as to regulate the output voltage V_{LED} at the light source 204. For example, the inductor current I_{L} can increase in a first time interval T_{ON} when the switch Q_{H} is on and the switch Q_{L} is off, decrease in a second time interval T_{OFF} when the switch Q_{H} is off and the switch Q_{L} is on, and is cut off in a third time interval T_{SKIP} when both the switches Q_{H} and Q_{L} are off. The PWM generating circuitry 210 can adjust a ratio of the time intervals T_{ON}, T_{OFF}, and T_{SKIP} to increase or decrease the output voltage V_{LED}. The voltage regulation circuitry 224 also includes a signal adjustor 208 that provides an adjusting signal V_{ADJ} indicative of an abovementioned target voltage V_{TARGET} to the PWM generating circuitry 210. The PWM generating circuitry 210 can control the ratio of the time intervals T_{ON}, T_{OFF}, and T_{SKIP} such that the output voltage V_{LED} increases if the output voltage V_{LED} is less than the target voltage V_{TARGET}, and decreases if the output voltage V_{LED} is greater than the target voltage V_{TARGET}. As a result, the output voltage V_{LED} is regulated to the target voltage V_{TARGET}.

Under control of the control circuit 232, the voltage regulation circuitry 224 and the current setting circuitry 230 can selectively operate in an illuminating mode, a single flashing mode, and a continuous flashing mode. In the illuminating mode, the current setting circuitry 230 sets the current I_{LED} to a predefined current level such that the light source 204 illuminates with a relatively stable brightness, and the voltage regulation circuitry 224 regulates the output voltage V_{LED} to be in a light-emitting voltage range such that the light source 204 receives sufficient power to illuminate properly. For example, if the light source 204 is used as a torch or a lamp, the control circuit 232 can control the voltage regulation circuitry 224 and the current setting circuitry 230 to operate in the illuminating mode.

In the single flashing mode, the current setting circuitry 230 sets the current I_{LED} to a preset current level I_{PRE} and maintains the current I_{LED} for a predetermined time interval. During the predetermined time interval, the voltage regulation circuitry 224 regulates the output voltage V_{LED} to be in a light-emitting voltage range such that the light source 204 receives sufficient power to emit light, and when the predetermined time interval expires, the voltage regulation circuitry 224 disables the power supply to the light source 204, e.g., by turning off the switches Q_{H} and Q_{L}. Thus, the light source 204 can flash/strobe for one time. For example, if the light source 204 is used as a strobe light in a camera or a mobile device having a camera module, and the camera or the mobile device is used to shoot a photo in a dark place, the control circuit 232 can control the voltage regulation circuitry 224 and the current setting circuitry 230 to operate in the single flashing mode.

In the continuous flashing mode, the control circuit 232 controls the voltage regulation circuitry 224, the current setting circuitry 230, and the light source 204 to selectively operate in different states that include a strobe state and an idle state, e.g., alternate between the strobe state and the idle state. In the strobe state, similarly to the single flashing mode, the current setting circuitry 230 sets the current I_{LED} to a first current level I_{RH} such that the light source 204 emits light, and the current setting circuitry 230 maintains the current I_{LED} for a first time interval T_{STB}. During the time interval T_{STB}, the voltage regulation circuitry 224 regulates the output voltage V_{LED} to be in a light-emitting voltage range with the current I_{LED} at the first current level I_{RH} such that the light source 204 receives sufficient power to emit light. When the time interval T_{STB} expires, the voltage regulation circuitry 224 and the current setting circuitry 230 operate in the idle state. In the idle state, the current setting circuitry 230 sets the current I_{LED} to a second current level I_{RL} that is less than the first current level I_{RH} such that the light source 204 disables emission of light, and the current setting circuitry 230 maintains the current I_{LED} for a second time interval T_{BLK}. During the time interval T_{BLK}, the voltage regulation circuitry 224 maintains the output voltage V_{LED} at a voltage level in the light-emitting voltage range. Hence, the light source 204 can emit light in the strobe state and disables emission of light in the idle state. The current setting circuitry 230 can control the light source 204 to selectively operate in the strobe state or the idle state by setting the current I_{LED} to the first current level I_{RH} in the strobe state and setting the current I_{LED} to the second current level I_{RL} in the idle state. As a result, the light source 204 can flash/strobe for multiple times continuously, by operating in the strobe state and the idle state alternately. For example, if the light source 204 is used as a strobe light in a camera or a mobile device having a camera module, and the camera or the mobile device is used to shoot continuous photos in a dark place, the control circuit 232 can control the voltage regulation circuitry 224 and the current setting circuitry 230 to operate in the continuous flashing mode.

As mentioned above, in one embodiment, the output voltage V_{LED} at the light source 204 is regulated to be in a light-emitting voltage range that enables the light source 204 to emit light during the strobe state, and the output voltage V_{LED} is maintained at a voltage level in the light-emitting voltage range during the idle state. Thus, when the controller 202 controls the light source 204 to transition from an idle state to a strobe state, it takes no time to provide an output voltage V_{LED} that is high enough to enable the light source 204 to emit light because the output voltage V_{LED} is already at that level. Additionally, it can take a relatively short time for the current setting circuitry 230 to set the current I_{LED} from the second current level I_{RL} to the first current level I_{RH}. As a result, the light source 204 can flash/strobe at a relatively high frequency.

In one embodiment, the controller 202 includes a first pin, e.g., labeled “LX,” operable for providing power to the light source 204 through the inductor L, and a second pin, e.g., labeled “ISEN,” operable for receiving the current I_{LED} of the light source 204. The controller 202 also includes control circuitry, e.g., including the voltage regulation circuitry 224, the current regulation circuitry 230, and the control circuit 232, that can selectively operate in a strobe state or an idle state. In the strobe state, the control circuitry controls the power at the pin LX to regulate the output voltage V_{LED} at the light source 204 to be in an abovementioned light-emitting voltage range such that the light source 204 emits light. In the strobe state, the control circuitry also regulates the current I_{LED} of the light source 204 to an abovementioned first current level I_{RH} such that the light source 204 emits light. In the idle state, the control circuitry controls the power at the pin LX to maintain the output voltage V_{LED} at a voltage level in the light-emitting voltage range. In the idle state, the control circuitry also regulates the current I_{LED} to an abovementioned second current level I_{RL} such that the light source 204 disables emission of light.

Additionally, in one embodiment, the controller 202 includes a power input pin labeled “IN” operable for receiving input power from a power source, e.g., a battery. The controller 202 includes a data pin labeled “SDA” operable for receiving or providing data, e.g., command information, status information, etc., and a clock pin labeled “SDC” operable for receiving or providing a clock signal to support data communication at the pin SDA. The controller 202 also includes an enable/disable pin labeled “STROBE” operable for enabling or disabling light emission at the light source 204, and a current setting pin labeled “BLANK” operable for setting the level of the current I_{LED} when the light source 204 emits light.

More specifically, in one embodiment, the controller 202 can selectively operate in an external control mode or an internal control mode according to a command signal received through the pins SDA and SDC. In the external control mode, the controller 202 can control the light source 204 to turn on or off, e.g., emit light or extinguish, by setting a logic signal at the pin STROBE to logic high or logic low. In the internal control mode, the control circuit 232 in the controller 202 can control the light source 204 to perform an above mentioned continuous flashing mode according to instructions stored in the control circuit 232, and the pin STROBE may be used to receive a trigger signal that triggers the continuous flashing mode. Moreover, in one embodiment, a battery that provides power to the controller 202 and the light source 204 may also provide power to a load (not shown). If the battery is powering a heavy load, e.g., a load consuming relatively high power, then the control circuit 232 may receive a control signal at the current setting pin BLANK that controls the current setting circuitry 230 to reduce a target current level of the current I_{LED} when the light source 204 emits light. For example, the current setting circuitry 230 can reduce the preset current level I_{PRE} in the single flashing mode or the first current level I_{RH} in the continuous flashing mode.

FIG. 2B illustrates a circuit diagram of an example of the light source controller 202, in an embodiment according to the present invention. FIG. 2B is described in combination with FIG. 2A.

The PWM generating circuitry 210 can be implemented in many different circuit structures and FIG. 2B shows an example thereof. In the example of FIG. 2B, the PWM generating circuitry 210 includes a feedback circuit 212 (e.g., a resistor divider) that generates a feedback signal V_{F} representing the output voltage V_{LED}, and an error amplifier 214 (e.g., an operational transconductance amplifier) that cooperates with a compensation circuit (e.g., including a capacitor C_{COM} and a resistor R_{COM}) to generate a PWM adjusting signal P_{ADJ} according to a comparison between the feedback signal V_{F} with an abovementioned adjusting signal V_{ADJ}. An adder 218 receives a ramp signal from a ramp signal generator 222, and a sense signal S_{ILX}, representing a current I_{LX} flowing through a connection node, e.g. the pin LX, of the switches Q_{H} and Q_{L}, from a current sensor 206. The adder 218 also generates a summed signal S_{SUM} of the ramp signal from the ramp signal generator 222 and the sense signal S_{ILX} from the current sensor 206. A comparator 216 compares the PWM adjusting signal P_{ADJ} with the summed signal S_{SUM} and generates a PWM signal according to the comparison. The PWM signal controls a driver circuit 220 to turn on the switches Q_{H} and Q_{L} alternately, so as to control the output voltage V_{LED}. The switch Q_{H} can be a p-channel MOSFET (metal-oxide-semiconductor field-effect transistor) and the switch Q_{L} can be an n-channel MOSFET. Thus, in the example of FIG. 2B, if the feedback signal V_{F} is less than the adjusting signal V_{ADJ}, the PWM adjusting signal P_{ADJ} can reduce a duty cycle of the PWM signal to increase the output voltage V_{LED}, or if the feedback signal V_{F} is greater than the adjusting signal V_{ADJ}, the PWM adjusting signal P_{ADJ} can increase the duty cycle of the PWM signal to reduce the output voltage V_{LED}. As a result, the output voltage V_{LED} is regulated to a target voltage V_{TARGET} determined by the adjusting signal V_{ADJ}.

In one embodiment, the abovementioned current setting circuitry 230 includes a current regulation circuit 240 and a reference setting circuit 238. The current regulation circuit 240 can regulate a current I_{LED} of the light source 204 to a reference current level I_{REF} and the reference setting circuit 238 can set the reference current level I_{REF}. For instance, the reference setting circuit 238 can set the reference current level I_{REF} to an abovementioned first current level I_{RH} in a strobe state, and set the reference current level I_{REF} to an abovementioned second current level I_{RL} in an idle state.

More specifically, in one embodiment, the current regulation circuit 240 includes a switch Q_{REF}, a resistive component R_{REF}, and an operational amplifier 242. The switch Q_{REF} and the resistive component R_{REF} are coupled to the light source 204 and allow the current I_{LED} of the light source 204 to pass through them. The operational amplifier 242 includes a first input terminal, e.g., a non-inverting terminal, operable for receiving a reference voltage VI_{REF}, a second input terminal, e.g., an inverting terminal, operable for applying a level of the reference voltage VI_{REF} to the resistive component R_{REF} to set the current I_{LED}, and an output terminal operable for controlling the switch Q_{REF}. Thus, the current I_{LED} can be regulated to a current level of VI_{REF}/R_{REF}, where VI_{REF} represents a level of the reference voltage and R_{REF} represents a resistance value of the resistive component. The reference setting circuit 238 can set the reference voltage VI_{REF} to a level indicative of the first current level I_{RH} in the strobe state, and set the reference voltage VI_{REF} to a level indicative of the second current level I_{RL} in the idle state.

Additionally, in the strobe state, the current regulation circuit 240 may act as a sensing circuit that senses the current I_{LED} of the light source 204 to generate a sense signal V_{SEN}, e.g., a voltage signal. The reference setting circuit 238 can include a comparing circuit (not shown) that compares the sense signal V_{SEN} with a preset threshold V_{PRE}. In one embodiment, the preset threshold V_{PRE} depends on the reference voltage VI_{REF} or the first current level I_{RH}. The comparing circuit can generate a control signal, e.g., a control signal 234 to the signal adjustor 208, to control the output voltage V_{LED} according to a result of the comparison of the sense signal V_{SEN} and the preset threshold V_{PRE}, which can result in maintaining the current I_{LED} at the first current level I_{RH}.

More specifically, in one embodiment, the switch Q_{REF} can be, but is not limited to, an n-channel MOSFET and can operate in a saturation region. When the switch Q_{REF} operates in the saturation region, the sense signal V_{SEN} at the drain terminal of the switch Q_{REF} can be greater than a voltage level of V_{GS}−V_{TH}+I_{LED}*R_{REF}, where V_{GS} represents a gate-source voltage of the switch Q_{REF}, V_{TH} represents a turn-on threshold voltage V_{TH} of the switch Q_{REF}, and I_{LED}*R_{REF} represents a voltage across the resistive component R_{REF}. If the current I_{LED} is at the first current level I_{RH}, then the gate-source voltage V_{GS} can be at a known voltage level V_{GS}_{_{—}}_{KNOWN}, e.g., determined by the first current level I_{RH} and a transconductance gₘ of the switch Q_{REF}, and the voltage I_{LED}*R_{REF} across the resistive component R_{REF} can be equal to the reference voltage VI_{REF}. Thus, if the current I_{LED} is at the first current level I_{RH}, the sense signal V_{SEN} is greater than a known voltage level of V_{GS}_{_{—}}_{KNOWN}−V_{TH}+VI_{REF}. However, in some situations, the output voltage V_{LED} applied to the light source 204 may be too low to allow a current I_{LED} at the first current level I_{RH} to flow through the light source 204. In other words, the current I_{LED} may be less than the first current level I_{RH} due to insufficient power received at the light source 204. If the current I_{LED} is less than the first current level I_{RH}, then the sense signal V_{SEN} is less than the voltage level of V_{GS}_{_{—}}_{KNOWN}−V_{TH}+VI_{REF}. Additionally, in some situations, the output voltage V_{LED} applied to the light source 204 may be too high such that a relatively high voltage drop is applied to (or wasted on) the drain-source channel of the switch Q_{REF}. In one embodiment, if the sense signal V_{SEN} is greater than a preset threshold V_{PRE}, e.g., given by the voltage level of V_{GS}_{_{—}}_{KNOWN}−V_{TH}+VI_{REF} plus a predetermined amount ΔV, then the output voltage V_{LED} is considered to be too high.

In one embodiment, the comparing circuit in the reference setting circuit 238 compares the sense signal V_{SEN} with the preset threshold V_{PRE} (e.g., given by V_{GS}_{_{—}}_{KNOWN}−V_{TH}+VI_{REF}+ΔV) to generate a control signal 234. In the strobe state, the voltage regulation circuitry 224 adjusts a target voltage V_{TARGET} of the output voltage V_{LED} according to the control signal 234. For example, if the sense signal V_{SEN} is less than the preset threshold V_{PRE}, then the control signal 234 controls the signal adjustor 208 to increase the adjusting signal V_{ADJ} so as to increase the target voltage V_{TARGET}; or if the sense signal V_{SEN} is greater than the preset threshold V_{PRE}, then the control signal 234 controls the signal adjustor 208 to decrease the adjusting signal V_{ADJ} so as to decrease the target voltage V_{TARGET}. As a result, if the light source 204 receives insufficient power, the controller 202 can increase the output voltage V_{LED} to increase the current I_{LED}; if the light source 204 receives sufficient power, the current I_{LED} can be regulated to the first current level I_{RH}; or if the output voltage V_{LED} is too high, the controller 202 can reduce the output voltage V_{LED} and maintain the current I_{LED} at the first current level I_{RH}.

In other words, in one embodiment, in the strobe state, the voltage regulation circuitry 224 can regulate the output voltage V_{LED} to be in a light-emitting voltage range such that the light source 204 emits light, e.g., with a predetermined brightness determined by the first current level I_{RH}. The light-emitting voltage range may depend on the first current level I_{RH}, parameters such as the transconductance gₘ, and the turn-on threshold voltage V_{TH} of the switch Q_{REF}, a resistance R_{REF}, and/or a nominal operating voltage V_{NOR} of the light source 204, etc. In one embodiment, a minimum voltage of the light-emitting voltage range is equal to or greater than a threshold voltage that enables the light source 204 to emit light. For example, a minimum voltage of the light-emitting voltage range can be equal to or greater than a voltage level of V_{GS}_{_{—}}_{KNOWN}−V_{TH}+VI_{REF}+V_{NOR}.

In one embodiment, in the idle state, the voltage regulation circuitry 224 maintains the output voltage V_{LED} at a voltage level, e.g., an abovementioned target voltage V_{TARGET}, in the light-emitting voltage range. By way of example, the signal adjustor 208 can maintain the target voltage V_{TARGET} at a preset level within the light-emitting voltage range by setting the adjusting signal V_{ADJ}. In one embodiment, the preset level is equal to an abovementioned preset threshold V_{PRE} (e.g., given by V_{GS}_{_{—}}_{KNOWN}−V_{TH}+VI_{REF}+ΔV). In an alternative embodiment, the signal adjustor 208 may record information for the target voltage V_{TARGET} (e.g., information for the adjusting signal V_{ADJ}) when the controller 202 transitions from a strobe state to an idle state, and the preset level of the target voltage V_{TARGET} in the idle state can be equal to the recorded target voltage V_{TARGET}. In yet another embodiment, the preset level of the target voltage V_{TARGET} in the idle state is an arbitrary level in the light-emitting voltage range.

In addition, in the idle state, the reference setting circuit 238 and the current regulation circuit 240 can set the current I_{LED} to a second current level I_{RL} such that the light source 204 disables emission of light. As used herein, “disable emission of light” means that a current flowing through a light source is zero amperes and therefore the light source does not emit light, or means that a current flowing through a light source is relatively small such that the light source emits light with a relatively small brightness which can be neglected. In one embodiment, the second current level I_{RL} is set to zero amperes, e.g., the reference voltage VI_{REF} is set to zero volts, and therefore the switch Q_{REF} is turned off by the operational amplifier 242. In one such embodiment, the light source 204 can extinguish the light completely. In an alternative embodiment, the value of the second current level I_{RL} is greater than zero amperes but is negligibly small, and the switch Q_{REF} is controlled to operate in a saturation region. Although an output voltage V_{LED} in the light-emitting voltage range is provided at the light source 204, at least a part of the output voltage V_{LED} is applied to, e.g., a drain-source channel of, the switch Q_{REF} such that a voltage across the light source 204 is less than a threshold voltage that enables the light source 204 to emit light with the abovementioned predetermined brightness. In one such embodiment, the light source 204 may emit light with a negligible brightness, which can be considered to be invisible or undetectable compared with the predetermined brightness of light in the strobe state.

Consequently, the controller 202 can control the light source 204 to alternate between a strobe state and an idle state such that the light source 204 flashes/strobes continuously. Since it can take a relatively short time to set the current I_{LED} from the second current level I_{RL} to the first current level I_{RH}, the controller 202 can enable the light source 204 to emit light within a relatively short time when transitioning from an idle state to a strobe state. The light source 204 can flash/strobe at a relatively high frequency.

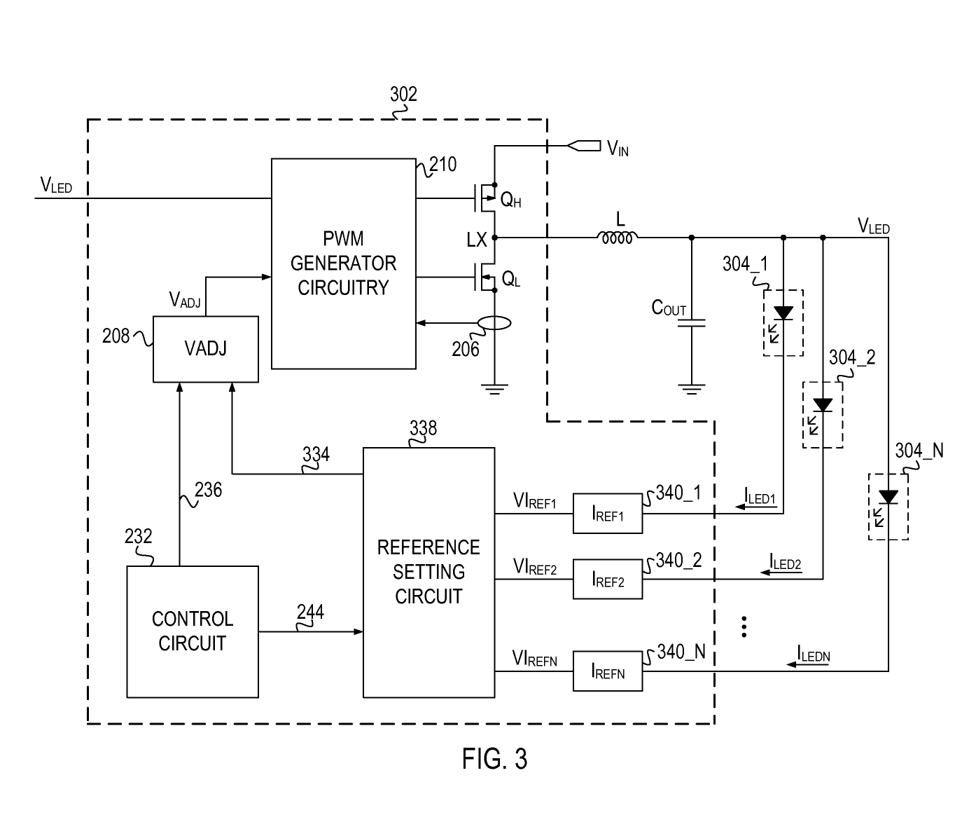

FIG. 3 illustrates a block diagram of another example of a light source controller 302, in an embodiment according to the present invention. FIG. 3 is described in combination with FIG. 2A and FIG. 2B.

The controller 302 in FIG. 3 is similar to the controller 202 in FIG. 2A except that the controller 302 controls multiple light sources 304_1-304_N (N=2, 3, 4 . . . ). The controller 302 includes multiple current regulation circuits 340_1-340_N and a reference setting circuit 338. The current regulation circuits 340_1-340_N can regulate currents I_{LED1}, I_{LED2}, . . . , I_{LEDN} of the light sources 304_1-304_N to corresponding reference current levels I_{REF1}, I_{REF2}, . . . , I_{REFN}, respectively. In a strobe state, the reference setting circuit 338 can set the reference current levels I_{REF1}, I_{REF2}, . . . , I_{REFN} to first current levels I_{RH1}, I_{RH2}, . . . , I_{RHN}, respectively. In an idle state, the reference setting circuit 338 can set the reference current levels I_{REF1}, I_{REF2}, . . . , I_{REFN} to second current levels I_{RL1}, I_{RL2}, . . . , I_{RLN}, respectively. The second current levels I_{RL1}, I_{RL2}, . . . , I_{RLN} are less than the first current levels I_{RH1}, I_{RH2}, . . . , I_{RHN}, respectively. In one embodiment, each of the regulation circuits 340_1-340_N can have a structure similar to that of the current regulation circuit 240 in FIG. 2B.

Additionally, the controller 302 may include sensing circuits, e.g., regulation circuits 340_1-340_N or other circuits not shown in FIG. 3, to sense the currents I_{LED1}, I_{LED2}, . . . , I_{LEDN} of the light sources 304_1-304_N. According to a result of sensing the currents I_{LED1}, I_{LEDN}, . . . , I_{LEDN}, the reference setting circuit 338 can determine whether the light sources 304_1-304_N receive sufficient power or whether the output voltage V_{LED} that powers the light sources 304_1-304_N is too high, and can generate a control signal 334 accordingly. Similarly to the control signal 234 in FIG. 2A, the control signal 334 can control the signal adjustor 208 to adjust the output voltage V_{LED} in a strobe state.

In the examples of FIG. 2A, FIG. 2B, and FIG. 3, the disclosed light source controllers 202 and 302 are controllers for buck converters. For example, the controller 202 or the controller 302 can receive an input voltage V_{IN}, and cooperate with an inductor L to convert the input voltage V_{IN} to an output voltage V_{LED} that is less than the input voltage V_{IN}. However, the invention is not so limited. A light source controller in another embodiment of the present invention can be a controller for a boost converter. A light source controller in yet another embodiment of the present invention can be a controller for a bust-boost converter.

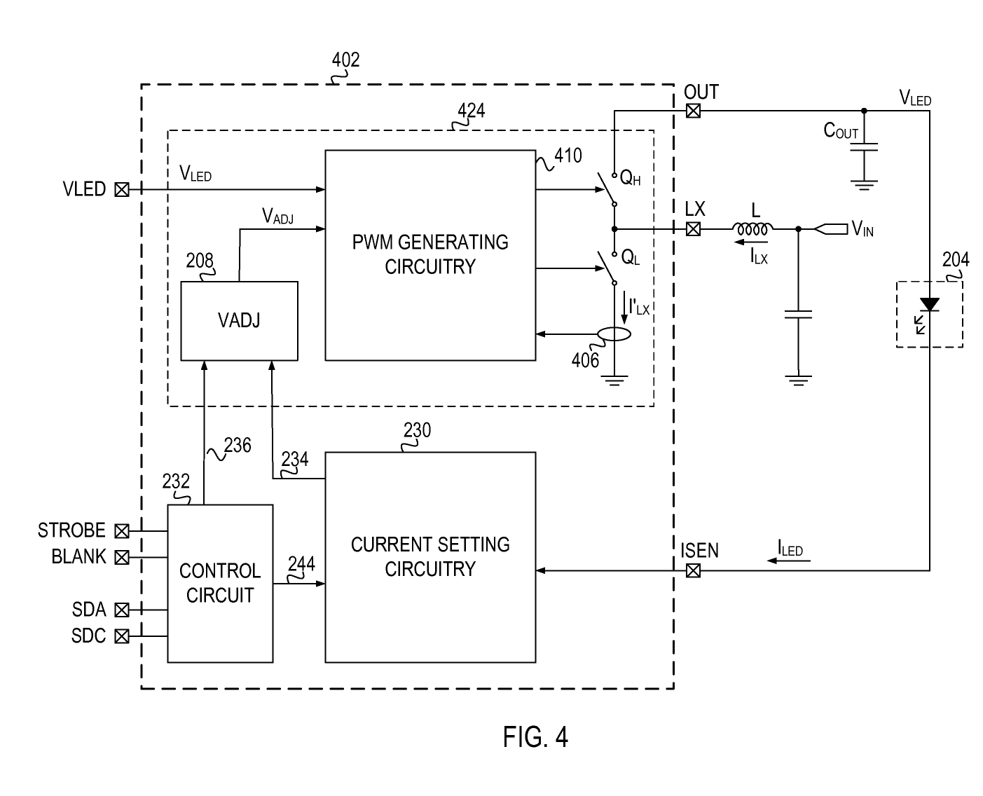

FIG. 4 illustrates a block diagram of another example of a light source controller 402, in an embodiment according to the present invention. FIG. 4 is described in combination with FIG. 2A, FIG. 2B, and FIG. 3.

In the example of FIG. 4, the controller 402 is a controller for a boost converter. For example, the controller 402 can cooperate with the inductor L to convert an input voltage V_{IN} received at the inductor L to an output voltage V_{LED} that is greater than the input voltage V_{IN}. The boosted output voltage V_{LED} can be used to power the light source 204. The PWM generating circuitry 410 and the current sensor 406 in FIG. 4 can have functions similar to those of the abovementioned PWM generating circuitry 210 and current sensor 206 except that the PWM generating circuitry 410 can be used to control a boost conversion and the PWM generating circuitry 210 can be used to control a buck conversion, and except that the current sensor 406 can be used to sense a current flowing from a connection node of the switches Q_{H} and Q_{L} to ground and the current sensor 206 can be used to sense a current flowing from ground to the connection node.

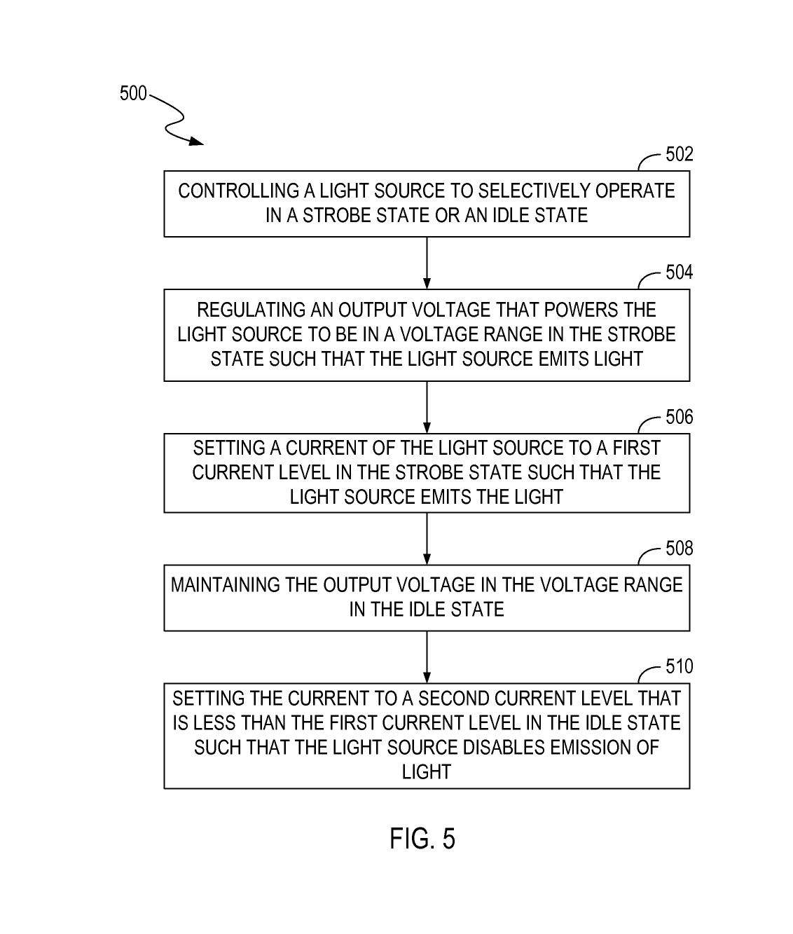

FIG. 5 illustrates a flowchart 500 of an example of a method for controlling a light source, in an embodiment according to the present invention. FIG. 5 is described in combination with FIG. 2A, FIG. 2B, FIG. 3, and FIG. 4.

At step 502, a light source controller, e.g., 202, 302, or 402, controls a light source, e.g., 204 or 304_1-304_N, to selectively operate in a strobe state or an idle state.

At step 504, voltage regulation circuitry, e.g., 224 or 424, regulates an output voltage V_{LED} that powers the light source to be in a light-emitting voltage range in the strobe state such that the light source emits light.

At step 506, current setting circuitry, e.g., 230, sets a current I_{LED} of the light source to a first current level I_{RH} in the strobe state such that the light source emits light.

At step 508, the voltage regulation circuitry, e.g., 224 or 424, maintains the output voltage V_{LED} in the light-emitting voltage range in the idle state.

At step 510, the current setting circuitry, e.g., 230, sets the current I_{LED} of the light source to a second current level I_{RL} that is less than the first current level I_{RH} in the idle state such that the light source disables emission of light.

In summary, embodiments according to the present invention pertain to light source controllers operable for controlling light sources to alternate between a strobe state and an idle state. The light source emits light in the strobe state, and disables emission of light in the idle state. The controller can maintain a voltage that powers the light source to be in a light-emitting voltage range whether the light source is in the strobe state or the idle state. The controller can also set a current of the light source to a first current level to enable light emitting in the strobe state, and set the current of the light source to a second current level to disable the light emitting in the idle state. As a result, the light source can be enabled to emit light within a relatively short time when transitioning from an idle state to a strobe state, and the light source can flash/strobe at a relatively high frequency. The light source controller according to the present invention can be used in many applications, e.g., mobile phones, tablet computers, cameras, portable chargers, etc.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A controller comprising:
current setting circuitry operable for selectively operating in different states, said states including a strobe state and an idle state, setting a current of a light source to a first current level in said strobe state such that said light source emits light, and setting said current to a second current level that is less than said first current level in said idle state such that said light source disables emission of light; and
voltage regulation circuitry, coupled to said current setting circuitry, operable for regulating an output voltage that powers said light source to be in a voltage range with said current at said first current level in said strobe state such that said light source emits light, and maintaining said output voltage at a voltage level in said voltage range in said idle state.

2. The controller of claim 1, wherein said current setting circuitry comprises:
a sensing circuit operable for sensing said current to generate a sense signal; and
a comparing circuit, coupled to said sensing circuit, operable for comparing said sense signal with a preset threshold, and generating a control signal to said voltage regulation circuitry to control said output voltage according to a result of said comparing.

3. The controller of claim 2, wherein said voltage regulation circuitry regulates said output voltage to a target voltage; wherein in said strobe state, said voltage regulation circuitry adjusts said target voltage according to said control signal, and wherein in said idle state, said voltage regulation circuitry maintains said target voltage at a preset level.

4. The controller of claim 3, wherein in said strobe state, said voltage regulation circuitry increases said target voltage if said sense signal is less than said preset threshold, and decreases said target voltage if said sense signal is greater than said preset threshold.

5. The controller of claim 1, wherein said current setting circuitry comprises:
a regulation circuit operable for regulating said current to a reference current level; and
a reference setting circuit, coupled to said regulation circuit, operable for setting said reference current level to said first current level in said strobe state, and setting said reference current level to said second current level in said idle state.

6. The controller of claim 5, wherein said regulation circuit comprises:
a switch operable for allowing said current to pass through said switch;
a resistive component, coupled to said switch, operable for allowing said current to pass through said resistive component; and
an operational amplifier, coupled to said resistive component and said switch, and comprising a first input terminal operable for receiving a reference voltage, a second input terminal operable for applying a level of said reference voltage to said resistive component to set said current, and an output terminal operable for controlling said switch.

7. The controller of claim 1, wherein the minimum voltage of said voltage range is equal to or greater than a threshold voltage that enables said light source to emit light.

8. An electronic device comprising:
a light source operable for emitting light in a strobe state and disabling emission of light in an idle state;
current setting circuitry, coupled to said light source, operable for controlling said light source to operate in said strobe state by setting a current of said light source to a first current level in said strobe state, and controlling said light source to operate in said idle state by setting said current to a second current level that is less than said first current level in said idle state; and
voltage regulation circuitry, coupled to said light source and said current setting circuitry, operable for regulating an output voltage that powers said light source to be in a voltage range with said current at said first current level in said strobe state such that said light source emits light, and maintaining said output voltage at a voltage level in said voltage range in said idle state.

9. The electronic device of claim 8, wherein said current setting circuitry comprises:
a sensing circuit operable for sensing said current to generate a sense signal; and
a comparing circuit, coupled to said sensing circuit, operable for comparing said sense signal with a preset threshold, and generating a control signal to said voltage regulation circuitry to control said output voltage according to a result of said comparing.

10. The electronic device of claim 9, wherein said voltage regulation circuitry regulates said output voltage to a target voltage; wherein in said strobe state, said voltage regulation circuitry adjusts said target voltage according to said control signal, and wherein in said idle state, said voltage regulation circuitry maintains said target voltage at a preset level.

11. The electronic device of claim 10, wherein in said strobe state, said voltage regulation circuitry increases said target voltage if said sense signal is less than said preset threshold, and decreases said target voltage if said sense signal is greater than said preset threshold.

12. The electronic device of claim 8, wherein said current setting circuitry comprises:
a regulation circuit operable for regulating said current to a reference current level; and
a reference setting circuit, coupled to said regulation circuit, operable for setting said reference current level to said first current level in said strobe state, and setting said reference current level to said second current level in said idle state.

13. A method comprising:
controlling a light source to selectively operate in different states, said states including a strobe state and an idle state;
regulating an output voltage that powers said light source to be in a voltage range in said strobe state such that said light source emits light;
setting, using current setting circuitry coupled to said light source, a current of said light source to a first current level in said strobe state such that said light source emits said light;
maintaining said output voltage in said voltage range in said idle state; and
setting said current to a second current level that is less than said first current level in said idle state such that said light source disables emission of light.

14. The method of claim 13, wherein said regulating of said output voltage comprises:
sensing said current to generate a sense signal;
comparing said sense signal with a preset threshold; and
generating a control signal to control said output voltage according to a result of said comparing.

15. The method of claim 14, further comprising:
regulating said output voltage to a target voltage;
adjusting said target voltage according to said control signal in said strobe state; and
maintaining said target voltage at a preset level in said idle state.

16. The method of claim 13, further comprising:
regulating, using a regulation circuit, said current to a reference current level;
setting said reference current level to said first current level in said strobe state; and
setting said reference current level to said second current level in said idle state.

17. A controller comprising:
a first pin operable for providing power to a light source;
a second pin operable for receiving a current of said light source;
control circuitry, coupled to said first and second pins, operable for selectively operating in different states including a strobe state and an idle state, controlling said power to regulate an output voltage at said light source to be in a voltage range in said strobe state such that said light source emits light, regulating said current to a first current level in said strobe state such that said light source emits light, controlling said power to maintain said output voltage at a voltage level in said voltage range in said idle state, and regulating said current to a second current level that is less than said first current level in said idle state such that said light source disables emission of light.

18. The controller of claim 17, wherein said control circuitry comprises:
a sensing circuit operable for sensing said current to generate a sense signal; and
a comparing circuit, coupled to said sensing circuit, operable for comparing said sense signal with a preset threshold, and generating a control to control said output voltage according to a result of said comparing.

19. The controller of claim 18, wherein said control circuitry regulates said output voltage to a target voltage, wherein in said strobe state, said control circuitry adjusts said target voltage according to said control signal, and wherein in said idle state, said control circuitry maintains said target voltage at a preset level.

20. The controller of claim 17, wherein said control circuitry comprises:
a regulation circuit operable for regulating said current to a reference current level; and
a reference setting circuit, coupled to said regulation circuit, operable for setting said reference current level to said first current level in said strobe state, and setting said reference current level to said second current level in said idle state.
